(19) United States
(12) Patent Application Publication
(10) Pub. No.: US 2023/0319232 A1
(43) Pub. Date: Oct. 5, 2023

(54) AUTOMATIC VIDEO RECORD FUNCTIONALITY

(71) Applicant: QUALCOMM Incorporated, San Diego, CA (US)

(72) Inventors: Sandeep SETHIA, Bangaluru (IN); Tanmay AGARWAL, Najibabad (IN)

(21) Appl. No.: 17/714,055

(22) Filed: Apr. 5, 2022

(51) Int. Cl. H04N 5/77; G06V 40/19; G06V 20/40; H04N 5/225

(52) U.S. Cl. CPC H04N 5/772; G06V 40/19; G06V 20/41; H04N 5/2258

(57) ABSTRACT

The present disclosure generally relates to techniques for video recording. Some aspects of the present disclosure include systems and techniques for automatically initiating video recording. One example recording device may include at least one memory, and one or more processors coupled to the at least one memory and configured to: receive sensor data indicating an orientation associated with the recording device; detect a difference between statistical information associated with a first frame captured by a first video recording element and statistical information associated with a second frame captured by the first video recording element; determining whether to initiate video recording via the first video recording element based on the orientation and the detected difference; initiate the video recording based on the determination; and save the video recording to the at least one memory.

### FIELD

The present disclosure generally relates to techniques for video recording. Some aspects of the present disclosure include systems and techniques for automatically initiating video recording.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video from any system equipped with a camera device. The images and/or videos can be captured for recreational use, professional photography, surveillance, and automation, among other applications. Moreover, camera devices are increasingly equipped with specific functionalities for analyzing video data and surrounding environments. For example, many camera devices are equipped with image processing capabilities.

### SUMMARY

Certain aspects are directed towards a recording device. The recording device may include at least one memory, and one or more processors coupled to the at least one memory and configured to: receive sensor data indicating an orientation associated with the recording device; detect a difference between statistical information associated with a first frame captured by a first video recording element and statistical information associated with a second frame captured by the first video recording element; determining whether to initiate video recording via the first video recording element based on the orientation and the detected difference; initiate the video recording based on the determination; and save the video recording to the at least one memory.

Certain aspects are directed towards a method for video recording by recording device. The method may include receiving sensor data indicating an orientation associated with the recording device; detecting a difference between statistical information associated with a first frame captured by a first video recording element and statistical information associated with a second frame captured by the first video recording element; determining whether to initiate video recording via the first video recording element based on the orientation and the detected difference; initiating the video recording based on the determination; and saving the video recording to at least one memory.

Certain aspects are directed towards a non-transitory computer-readable medium having instructions, which when executed by one or more processors of a recording device, cause the recording device to: receive sensor data indicating an orientation associated with the recording device; detect a difference between statistical information associated with a first frame captured by a first video recording element and statistical information associated with a second frame captured by the first video recording element; determining whether to initiate video recording via the first video recording element based on the orientation and the detected difference; initiate the video recording based on the determination; and save the video recording.

In some aspects, one or more of the apparatuses described above is, can be part of, or can include a vehicle or component or system of a vehicle, a mobile device (e.g., a mobile telephone or so-called “smart phone” or other mobile device), an Internet-of-Things (IoT) device, an extended reality (XR) device (e.g., a virtual reality (VR) device, an augmented reality (AR) device, or a mixed reality (MR) device), a wearable device, a personal computer, a laptop computer, a tablet computer, a server computer, a robotics device or system, an aviation system, or other device. In some aspects, one or more of the apparatuses includes an image sensor (e.g., a camera) or multiple image sensors (e.g., multiple cameras) for capturing one or more images. In some aspects, one or more of the apparatuses includes one or more displays for displaying one or more images, notifications, and/or other displayable data. In some aspects, one or more of the apparatuses includes one or more speakers, one or more light-emitting devices, and/or one or more microphones. In some aspects, one or more of the apparatuses described above can include one or more sensors. For instance, the one or more sensors can include at least one of a light-based sensor (e.g., a LIDAR sensor, a radar sensor, etc.), an audio sensor, a motion sensor, a temperature sensor, a humidity sensor, an image sensor, an accelerometer, a gyroscope, a pressure sensor, a touch sensor, and a magnetometer. In some cases, the one or more sensors can be used for determining a location of the apparatuses, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a diagram illustrating an example recording device, in accordance with some examples.

FIGS. 2A and 2B illustrate techniques for triggering a notification to a user regarding video recording or automatically starting video recording, in accordance with certain aspects of the present disclosure.

FIG. 3 illustrates techniques for automatically starting video recording followed by a user notification, in accordance with certain aspects of the present disclosure.

FIG. 4 illustrates example techniques for providing user notification based on whether the user is interacting with a user interface (UI), in accordance with certain aspects of the present disclosure.

FIG. 5 illustrates techniques for determining whether to initiate video recording in accordance with certain aspects of the present disclosure.

FIG. 6 illustrates a video recording element receiving data for analyzing a gaze of a user, in accordance with certain aspects of the present disclosure.

FIG. 7 is a flow diagram illustrating an example process for video recording, in accordance with certain aspects of the present disclosure.

FIG. 8 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Capturing important moments or events by capturing video of the moments/events may be important for some users. In some situations, a user may want to record video of an event but may have forgotten to being a video recording or may have missed selection of a record option. For instance, a user may forget to press a record button or icon of a camera application of a device (e.g., a mobile device, a camera, etc.) while intending to record a video. In one illustrative example, while intending to record a moment during a birthday party, a user may have forgotten to press the record button or icon after placing their device in a video mode of operation and may miss an opportunity to record the moment as a result.

Systems, apparatuses, processes (also referred to as methods), and computer-readable media (collectively referred to herein as “systems and techniques”) are described herein for video recording. Certain aspects of the present disclosure provide techniques for automatically triggering video recording (or providing a notification to trigger video recording) based on detection of one or more factors that may indicate that a user intends (or previously intended) to capture a video. For example, if the user is in video mode for a period of time (e.g., 10 seconds) without pressing a start option (e.g., a record button or icon of a camera application of a device) to begin recording a video, a notification may be output (e.g., displayed, audibly played, via haptic feedback, etc.) to the user indicating that the recording is not enabled, notifying the user that he or she needs to select the start video option to start recording. As used herein, video mode of a device (also referred to as a recording device) generally refers to a mode where an option to start recording a video is provided to the user. For example, to transition to video mode, an application for recording video may be opened. In some cases, when in video mode, the user may see the image or scene being captured by a video recording element of the device before selecting to start recording (e.g., via one or more preview video frames being displayed on a display of the device).

In some examples, the notification to the user can be in the form of a blinking light (e.g., using one or more light-emitting diodes (LEDs)), a haptic feedback (e.g., vibration of the recording device), a popup message on a screen of the recording device, or any other suitable notification. The user may discard the notification if the user does not want to enable the recording.

In some aspects, the recording device may determine that the user has started a recording session (e.g., by putting the recording device in the video mode), yet has not started recording such as by selecting a start option to start recording. The recording device may automatically start recording video after a time period (e.g., 10 seconds) has elapsed and may keep recording until the user presses a stop recording option. The recording device may then save the recorded video in storage. In some aspects, the recording device may automatically record the video after a first time period (e.g., 10 seconds), and after a second longer time period (e.g., 15 minutes) output a notification (e.g., display a popup window, play audio, or output haptic feedback such as a vibration) to the user prompting the user to provide an input indicating whether to continue the recording or to stop the video recording. In some cases, if no response is received after a third time period (e.g., 3 seconds), the recording device may stop the recording and save the recorded video in storage. In some aspects, if the user is in video mode for a first time period (e.g., 10 seconds), a notification may be sent to the user indicating that the recording is not enabled, and if no response is received, the recording device may automatically start recording the video. After a second time period (e.g., 15 minutes), the recording device may output a notification to the user asking whether the user wants to continue the recording or not, and if no response is received after a third time period (e.g., 3 seconds), the recording device may stop the recording and save the recorded video in storage.

In some aspects, various techniques may be used to determine whether the user intends on recording video before automatically starting the video recording. For example, when using one video recording element (e.g., a rear-facing camera) for video recording, the recording device may use gaze information to determine whether the user intends to be recording. The gaze information may be retrieved based on data captured by another video recording element (e.g., a front-facing camera) or any suitable gaze sensor. If a gaze sensor is not available, a face detection algorithm may be used for eye tracking. Based on the gaze information, the recording device may determine whether the user intends on recording video. If the user's gaze is on the screen, this indicates that the user likely intends on recording video. In some cases, sensor information (e.g., information or data from a gyroscope, accelerometer, or other sensor) may be used to determine whether the user intends on recording video. For example, sensor information may be used to detect whether the user intends to change the settings on the recording device or has forgotten to start recording. The sensor information may indicate the orientation of the recording device. If the recording device is pointed down, this may indicate that user likely does not intend to record video. In some cases, statistics information from the camera preview frames may be used to detect if there is any scene change. For example, if the recording device is pointed at a dynamic scene with moving objects (e.g., as opposed to a wall), this indicates that the user likely intends to record video.

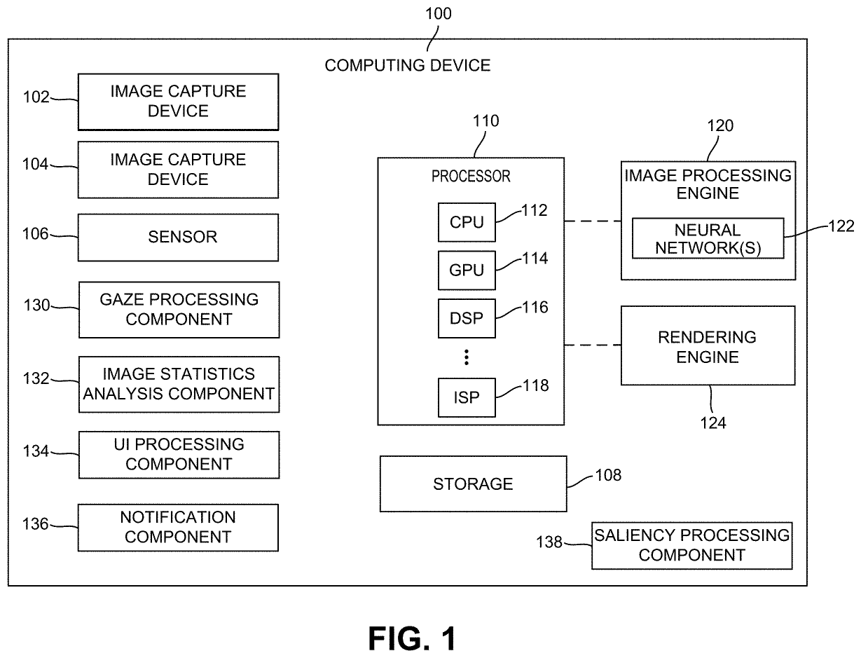

FIG. 1 is a diagram illustrating an example recording device 100, in accordance with some examples. In the example shown, the recording device 100 includes a video recording element 102, storage 108, processor 110, an image processing engine 120, one or more neural network(s) 122, and a rendering engine 124. As used herein, a recording device generally refers to any electronic device capable of recording video. The recording device 100 can also optionally include one or more additional video recording elements 104; one or more sensors 106, such as light detection and ranging (LIDAR) sensor, a radio detection and ranging (RADAR) sensor, an accelerometer, a gyroscope, a light sensor, an inertial measurement unit (IMU), a proximity sensor, etc. In some cases, the recording device 100 can include video recording elements capable of capturing images with different fields of view (FOVs) or facing different directions. For example, in dual camera or image sensor applications, the recording device 100 can include video recording elements with different types of lenses (e.g., wide angle, telephoto, standard, zoom, etc.) capable of capturing images with different FOVs (e.g., different angles of view, different depths of field, etc.). In some implementations, the recording device 100 may include one or more rear-facing cameras and one or more front-facing camera. A front-facing camera refers to a camera facing the same direction as a screen of the recording device, and a rear-facing camera refers to a camera facing an opposite direction as the screen of the recording device.

The recording device 100 may be any electronic device such as a camera system (e.g., a digital camera, an IP camera, a video camera, a security camera, etc.), a telephone system (e.g., a smartphone, a cellular telephone, a conferencing system, etc.), a desktop computer, a laptop or notebook computer, a tablet computer, a set-top box, a television, a display device, a digital media player, a game console, a video streaming device, a drone, a computer in a car, an IoT (Internet-of-Things) device, a smart wearable device, an extended reality (XR) device (e.g., a head-mounted display, smart glasses, etc.), or any other suitable electronic device(s).

In some implementations, the video recording element 102, the video recording element 104, the other sensor(s) 106, the storage 108, the processor 110, the image processing engine 120, the neural network(s) 122, and the rendering engine 124 can be part of the same recording device. For example, in some cases, the video recording element 102, the video recording element 104, the other sensor(s) 106, the storage 108, the processor 110, the image processing engine 120, the neural network(s) 122, and the rendering engine 124 can be integrated into a smartphone, laptop, tablet computer, smart wearable device, game system, XR device, and/or any other computing device. However, in some implementations, the video recording element 102, the video recording element 104, the other sensor(s) 106, the storage 108, the processor 110, the image processing engine 120, the neural network(s) 122, and/or the rendering engine 124 can be part of two or more separate computing devices.

In some examples, the video recording elements 102 and 104 can be any image and/or video capture devices, such as a digital camera, a video camera, a smartphone camera, a camera device on an electronic apparatus such as a television or computer, a camera system, etc. In some cases, the video recording elements 102 and 104 can be part of a camera or computing device such as a digital camera, a video camera, an IP camera, a smartphone, a smart television, a game system, etc. In some examples, the video recording elements 102 and 104 can be part of a dual-camera assembly. The video recording elements 102 and 104 can capture image and/or video content (e.g., raw image and/or video data), which can then be processed by the processor 110, the image processing engine 120, the neural network(s) 122, and/or the rendering engine 124 as described herein.

In some cases, the video recording elements 102 and 104 can include image sensors and/or lenses for capturing image data (e.g., still pictures, video frames, etc.). The video recording elements 102 and 104 can capture image data with different or same FOVs, including different or same angles of view, different or same depths of field, different or same sizes, etc. For example, in some cases, the video recording elements 102 and 104 can include different image sensors having different FOVs. In other examples, the video recording elements 102 and 104 can include different types of lenses with different FOVs, such as wide-angle lenses, telephoto lenses (e.g., short telephoto, medium telephoto), standard lenses, zoom lenses, etc. In some examples, the video recording element 102 can include one type of lens and the video recording element 104 can include a different type of lens. In some cases, the video recording elements 102 and 104 can be responsive to different types of light. For example, in some cases, the video recording element 102 can be responsive to visible light and the video recording element 104 can be responsive to infrared light.

The other sensor(s) 106 can be any sensor for detecting and measuring information such as distance, motion, position, depth, speed, etc. Non-limiting examples of sensors include LIDARs, ultrasonic sensors, gyroscopes, accelerometers, magnetometers, RADARs, IMUs, audio sensors, and/or light sensors. In one illustrative example, the sensor 106 can be a LIDAR configured to sense or measure distance and/or depth information which can be used when calculating depth-of-field and other effects. In some cases, the recording device 100 can include other sensors, such as a machine vision sensor, a smart scene sensor, a speech recognition sensor, an impact sensor, a position sensor, a tilt sensor, a light sensor, etc.

The storage 108 can include any storage device(s) for storing data, such as image data for example. The storage 108 can store data from any of the components of the recording device 100. For example, the storage 108 can store data or measurements from any of the video recording elements 102 and 104, the other sensor(s) 106, the processor 110 (e.g., processing parameters, outputs, video, images, segmentation maps, depth maps, filtering results, calculation results, etc.), and/or any of the image processing engine 120, the neural network(s) 122, and/or the rendering engine 124 (e.g., output images, processing results, parameters, etc.). In some examples, the storage 108 can include a buffer for storing data (e.g., video data).

In some implementations, the processor 110 can include a central processing unit (CPU) 112, a graphics processing unit (GPU) 114, a digital signal processor (DSP) 116, and/or an image signal processor (ISP) 118. The processor 110 can perform various operations such as image enhancement, feature extraction, depth estimation, computer vision, graphics rendering, XR (e.g., augmented reality, virtual reality, mixed reality, and the like), image/video processing, sensor processing, recognition (e.g., text recognition, object recognition, feature recognition, facial recognition, pattern recognition, scene recognition, etc.), foreground prediction, machine learning, filtering, depth-of-field effect calculations or renderings, tracking, localization, and/or any of the various operations described herein. In some examples, the processor 110 can implement the image processing engine 120, the neural network(s) 122, and the rendering engine 124. In other examples, the processor 110 can also implement one or more other processing engines.

The operations of the image processing engine 120, the neural network(s) 122, and the rendering engine 124 can be implemented by one or more components of the processor 110. In one illustrative example, the image processing engine 120 and the neural network(s) 122 (and associated operations) can be implemented by the CPU 112, the DSP 116, and/or the ISP 118, and the rendering engine 124 (and associated operations) can be implemented by the GPU 114. In some cases, the processor 110 can include other electronic circuits or hardware, computer software, firmware, or any combination thereof, to perform any of the various operations described herein.

While the recording device 100 is shown to include certain components, one of ordinary skill will appreciate that the recording device 100 can include more or fewer components than those shown in FIG. 1. For example, the recording device 100 can also include, in some instances, one or more memory devices (e.g., RAM, ROM, cache, and/or the like), one or more networking interfaces (e.g., wired and/or wireless communications interfaces and the like), one or more display devices, and/or other hardware or processing devices that are not shown in FIG. 1.

Certain aspects of the present disclosure provide techniques for automatically triggering recording based on analysis suggesting that a user intends to be recording video. For example, such analysis may include analyzing a gaze associated with the user. The recording device 100 may include a gaze processing component 130 which may receive image or video data captured by a front-facing camera (e.g., video recording element 104) and determine a gaze associated with the user. In some cases, the gaze processing component 130 may be any gaze sensor. If the recording device 100 is in a video mode and the gaze processing component 130 indicates that the user's gaze is at the camera (e.g., for a certain period of time), the processor 110 may determine to begin video recording.

In some cases, the recording device 100 may include an image statistics analysis component 132 which may analyze a video captured by a camera (e.g., by video recording element 102 or 104) and provide an indication of a frame-level rate of change (e.g., rate of change associated with a scene being captured) which may be used to detect whether to start the video recording. For example, if the camera is pointing at a dynamic scene or there is a high rate of change in the scene between frame transitions, this may indicate that the user may intend to be recording. To detect the rate of change, the recording device may detect a difference between statistical information associated with a first frame captured by the camera and statistical information associated with a second frame captured by the camera.

In some aspects, the recording device 100 may include a user interface (UI) processing component 134. The UI processing component 134 may detect whether a user is interacting with a UI of recording device 100. The recording device 100 may determine whether to initiate video recording based on whether the user is interacting with the UI as indicated by UI processing component 134. In some cases, recording device 100 may include a notification component 136 which may provide notifications to the user. For example, instead of initiating video recording (or in addition to initiating video recording), recording device 100 may send a notification (e.g., to inform the user that video recording has started, or ask whether the user intends to be recording). In some cases, recording device 100 may include a saliency processing component 138 which may process images or video to indicate visually salient regions or objects (e.g., regions or objects of interest that the user may focus on). Saliency may be detected using various suitable techniques, such as by detecting bright pixels in images. The output of saliency processing component 138 may be used by processor 110 to detect whether to trigger the video recording. One or more of gaze processing component 130, image statistics analysis component 132, UI processing component 134, notification component 136, saliency processing component 138 may be implemented as part of processor 110.

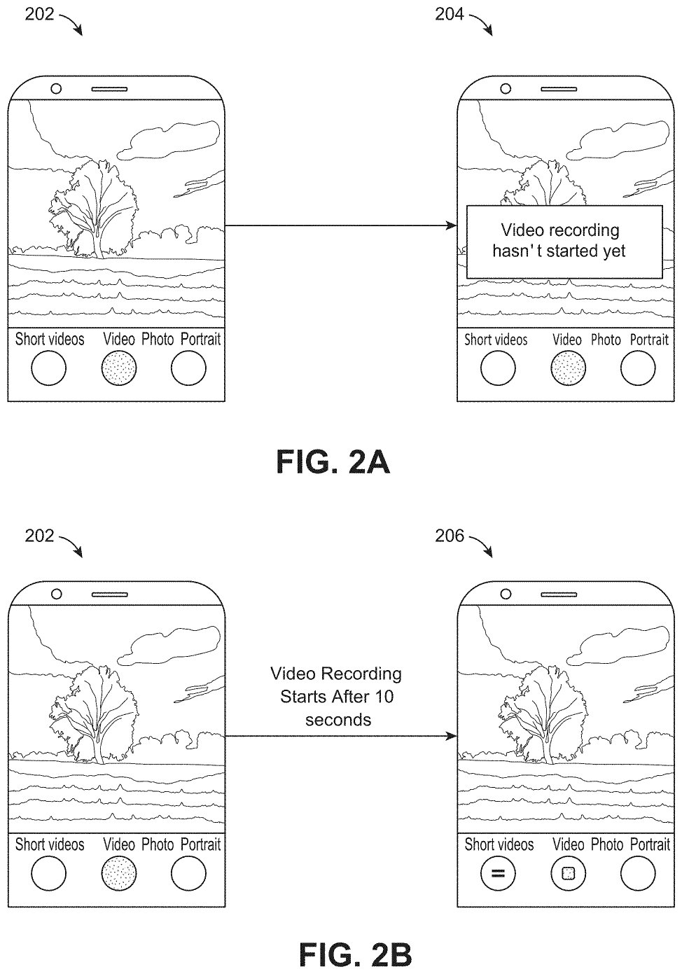

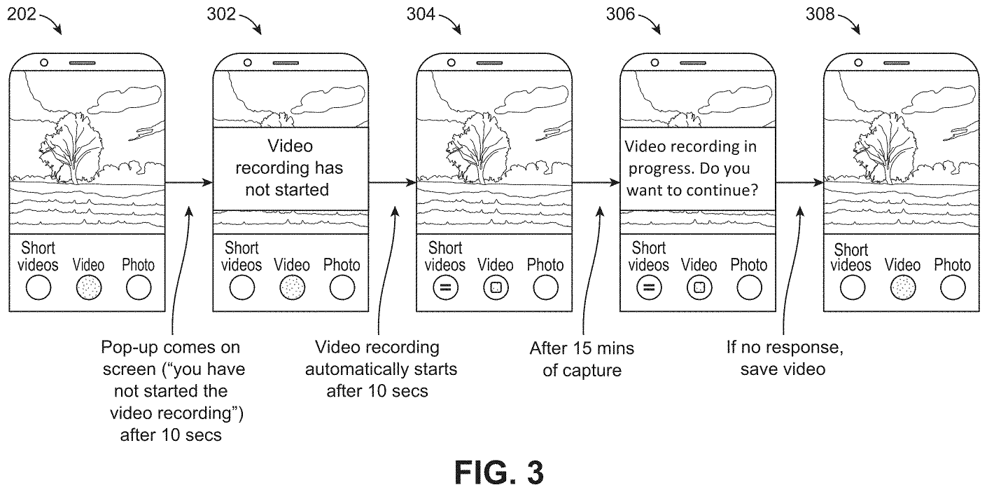

FIGS. 2A and 2B illustrate techniques for triggering a notification to a user regarding video recording or automatically starting video recording, in accordance with certain aspects of the present disclosure. As shown by diagram 202, a user may start a video mode of a recording device (e.g., recording device 100, such as a mobile device having a camera). Once the video mode has started, one or more operations may occur to determine whether to provide a notification to the user that the video recording has not yet started. For example, the recording device may wait a period of time (e.g., 10 seconds) before sending a notification to the user that video recording has not started as shown in diagram 204. As shown in FIG. 2B, the recording device may wait a period of time (e.g., 10 seconds) before automatically starting to record video as shown by diagram 206. In some cases, notification and automatic recording features may be combined, as described in more detail with respect to FIG. 3.

FIG. 3 illustrates techniques for automatically starting video recording followed by a user notification, in accordance with certain aspects of the present disclosure. As shown, in diagram 202, a user may begin a video mode of a recording device (e.g., recording device 100). After a period of time has elapsed (e.g., 10 seconds), the recording device may notify the user, indicating that the video recording has not been started, as shown by diagram 302.

Upon sending the notification to the user, the recording device may wait a period of time (e.g., another 10 seconds) before automatically initiating video recording, as shown by diagram 304. Once the video recording has been started, the recording device may send a notification to the user indicating that video recording is in progress. In some cases, the recording device allows the user to continue or stop the recording, as shown by diagram 306.

In some aspects, the notification to the user may be sent after a period of time has elapsed (e.g., 15 minutes), as shown. In some cases, if no response is received from the user indicating that the user wishes to continue recording, the video recording may be stopped and the recorded video may be saved to storage (e.g., storage 108, also referred to herein as memory), as shown by diagram 308.

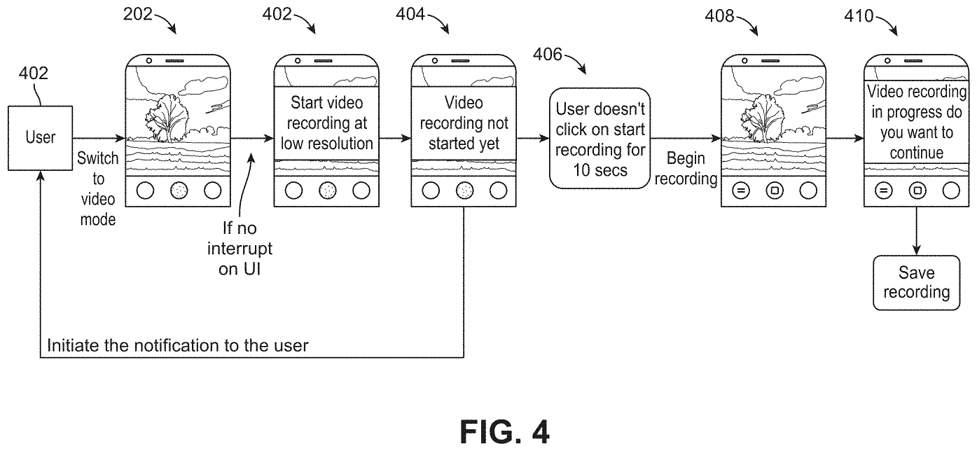

FIG. 4 illustrates example techniques for providing user notification based on whether the user is interacting with a UI of the recording device, in accordance with certain aspects of the present disclosure. As shown, the user 402 may initiate a video mode of the recording device, as shown by diagram 202. If the user is not interacting the UI associated with the video mode, the recording device may automatically begin video recording, as shown by diagram 202. For example, the UI processing component 134 of the recording device 100 may determine and provide an indication to the processor 110 of whether the user is interacting with the UI in video mode.

Based on the indication, the processor 110 may determine whether to initiate the video recording. In some aspects, to reduce memory consumption, the recording device starts the video recording with a low resolution. Interacting with the UI may involve providing any input to the recording device in video mode other than starting a video recording, such as adjusting video recording options or settings. Once the low-resolution video recording has been automatically started, a notification may be sent to user 402 indicating that the recording has not yet started (e.g., recording at full-resolution has not yet started), as shown by diagram 404.

At block 406, the recording device may determine that the user has not selected an option to start recording. In response, the recording device may begin video recording at full resolution, as shown by diagram 408. A notification may be sent to the user that video recording is in progress. In some cases, the recording device may request that the user provide an input indicating whether they intend on continuing the recording, as shown by diagram 410. If a response is not received from the user, the recording may be stopped and saved to storage.

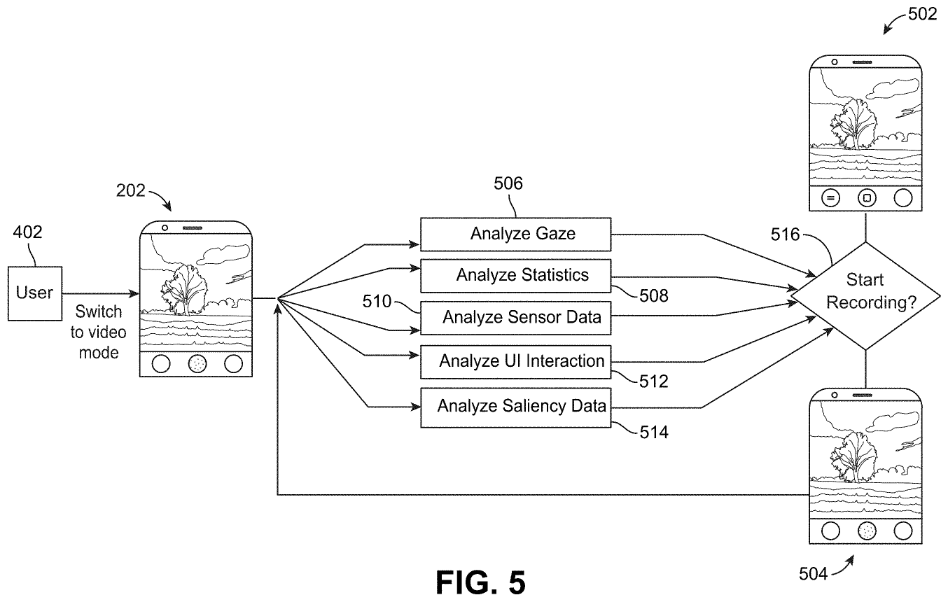

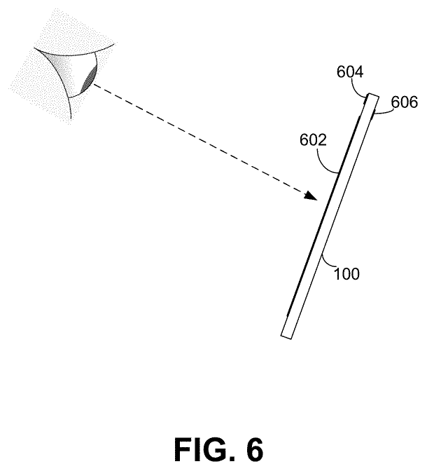

FIG. 5 illustrates techniques for determining whether to initiate video recording in accordance with certain aspects of the present disclosure. As shown, once a video mode has been started, the recording device may consider various factors to determine whether to initiate a video recording automatically. For example, at block 506, the recording device may consider gaze information. As described with respect to FIG. 1, gaze processing component 130 may analyze a gaze of a user of the recording device to determine whether the user's gaze is on the screen of the recording device. An illustrative example of analyzing a gaze of a user is described below with respect to FIG. 6.

FIG. 6 illustrates a video recording element receiving data for analyzing a gaze of a user, in accordance with certain aspects of the present disclosure. For example, as shown, a video recording element 604 (e.g., a front-facing camera) may be facing a user and may capture one or more images of the user's eye. The data from the video recording element 604 may be analyzed (e.g., at block 506 as described with respect to FIG. 5) by the recording device 100 to determine whether the user's gaze is directed at a screen 602 of the recording device 100. Based on the gaze information, the recording device 100 may initiate a video recording via a video recording element 606 (e.g., a rear-facing camera), or in some cases, via the video recording element 604.

Referring back to FIG. 5, the recording device may also analyze, at block 508, statistical information (e.g., via the image statistics analysis component 132 of FIG. 1). The statistical information may indicate a rate of change associated with captured data (e.g., captured by video recording element 606). For example, the rate of change may indicate the rate of change of a captured scene from one frame of video data to another frame of the video data. For instance, the recording device may detect a difference between statistical information associated with a first frame captured by a first video recording element and statistical information associated with a second frame captured by the first video recording element. In some cases, the rate of change may be an average rate of change associated with multiple frame transitions of the video data. The statistical information may also include various other inputs such as whether the video recording element is focused on an object in a scene being captured by the video recording element.

At block 510, the recording device may analyze sensor data (e.g., from sensor 106), such as data from a gyroscope or accelerometer. For example, sensor data from a gyroscope may indicate the orientation of the recording device. The recording device may determine whether the device is being held at an orientation (e.g., close to an upright orientation) that a device is typically held at to record video.

At block 512, the recording device may analyze UI interactions of the user (e.g., via the UI processing component 134 of FIG. 1). For example, the recording device may determine whether the user is interacting with a UI while in video mode, such as changing video record settings. Interacting with the UI may indicate that the user does not intend to be recording video. At block 516, the recording device may analyze saliency data (e.g., via saliency processing component 138 of FIG. 1). As described, saliency data may indicate visually salient regions of a scene being captured by the video recording element. The saliency data may be used to determine whether to initiate video recording automatically.

At block 516, the recording device may determine whether to initiate video recording based on one or more of the operations performed at blocks 506, 508, 510, 512, 514. For instance, if the recording device is being held at an orientation associated with video recording, and the statistical information indicates a rate of change of a scene greater than a threshold, the recording device may initiate video recording. In some cases, the recording device may also consider whether the user's gaze is on the screen as a factor for determining whether to initiate video recording. The recording device may initiate video recording if the user is not interacting with the UI, suggesting that the user intends to be recording video, especially if the user's gaze is on the screen. As shown, based on the decision at block 516, the recording device may either initiate video recording as shown in diagram 502, or forgo initiating video recording as shown in diagram 504 and continue to analyze the various factors described herein to determine whether to initiate video recording.

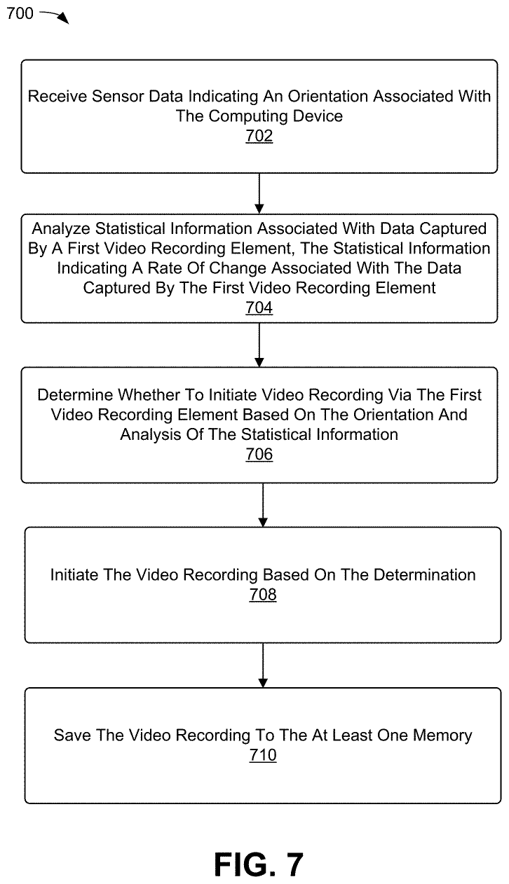

FIG. 7 is a flow diagram illustrating an example process 700 for video recording, in accordance with certain aspects of the present disclosure. The operations of process 700 may be performed by a recording device, such as the recording device 100 of FIG. 1. At block 702, the recording device may receive sensor data indicating an orientation associated with the recording device. For example, the sensor data may be received from a gyroscope or accelerometer (e.g., sensor 106).

At block 704, the recording device detects a difference between statistical information associated with a first frame captured by a first video recording element and statistical information associated with a second frame captured by the first video recording element. For example, the recording device may analyze statistical information associated with data captured by the first video recording element, the statistical information indicating a rate of change associated with the data captured by the first video recording element. In some cases, the detected difference includes a rate of change associated with frame transitions of the data captured by the first video recording element. In some aspects, to analyze the statistical information, the recording device may analyze whether the first video recording element is focused on an object in a scene captured by the first video recording element.

At block 706, the recording device determines whether to initiate video recording via the first video recording element based on the orientation and the detected difference (e.g., whether the detected difference meets a threshold). In some cases, the recording device may detect whether a user is interacting with a user interface of the recording device and determine whether to initiate the video recording based on the detection of whether the user is interacting with the user interface.

In some cases, the recording device may analyze a gaze associated with a user of the recording device and determine whether to initiate the video recording based on the analysis of the gaze. The recording device may receive data from a second video recording element capturing a scene including the user. The recording device may analyze the gaze associated with the user and determine whether the user is gazing at a screen of the recording device based on the data from the second video recording element. The second video recording element may be different than the first video recording element (or the second video recording element may be the same as the first video recording element). For example, the second video recording element may be a front-facing camera of the recording device and the first video recording element may be a rear-facing camera of the recording device.

In some cases, the recording device may receive a saliency input indicating a visually salient region of a scene captured by the first video recording element and determine whether to initiate the video recording based on the saliency input. In some aspects, prior to determining whether to initiate the video recording, the recording device may receive input from a user to start a video mode of the recording device. For example, starting the video mode may involve opening an application for recording video.

At block 708, the recording device initiates the video recording based on the determination at block 706. At block 710, the recording device saves the video recording (e.g., to memory). In some aspects, to initiate the video recording at block 708, the recording device may send a notification to a user to select an option that initiates the video recording. In some cases, the recording device may begin recording a low-resolution video via the first video recording element and buffer the low-resolution recording for a period of time. After beginning to record the low-resolution video, the recording device may send a notification to a user of the recording device that an option to begin the video recording has not been selected. The recording device may initiate the video recording after sending the notification.

In some scenarios, a user may forget to stop a video recording, resulting in power consumption and memory utilization. In some aspects, the recording device may stop the video recording based on one or any combination of factors or inputs described herein. For example, the recording device may stop the video recording based on a difference between statistical information associated with a third frame captured by the first video recording element and statistical information associated with a fourth frame captured by the first video recording element (e.g., if the difference is less than a threshold). The recording device may stop the recording based on whether a user is interacting with a user interface of the recording device, a gaze associated with the user of the recording device, sensor data (e.g., indicating the orientation of the recording device), whether the first video recording element is focused on an object in a scene captured by the first video recording element, or a saliency input indicating a visually salient region of a scene captured by the first video recording element.

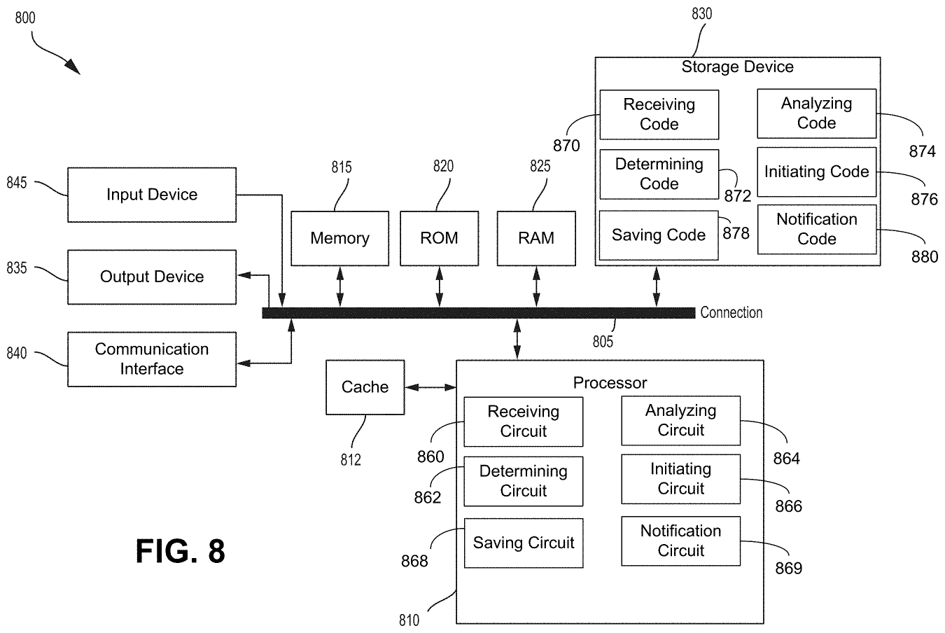

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service. In some aspects, code stored in storage device 830 may be configured to control processor 810 to perform operations described herein. In some aspects, the processor 810 may be a special-purpose processor where instructions or circuitry are incorporated into the actual processor design to perform the operations described herein. Processor 810 may essentially be a completely self-contained computing system, containing multiple cores or processors, a bus, memory controller, cache, etc. A multi-core processor may be symmetric or asymmetric. The processor 810 may include circuit 860 for receiving (e.g., receiving sensor data), circuit 862 for determining or detecting (e.g., determining whether to initiate video recording or detecting whether a user is interacting with UI), circuit 864 for analyzing (e.g., analyzing statistical information), circuit 866 for initiating (e.g., initiating or beginning video recording), circuit 868 for saving (e.g., saving video recording to memory), and circuit 869 for notifying (e.g., notifying a user).

The storage device 830 may store code which, when executed by the processors 810, performs the operations described herein. For example, the storage device 830 may include code 870 for receiving (e.g., receiving sensor data), code 872 for determining or detecting (e.g., determining whether to initiate video recording or detecting whether a user is interacting with UI), code 874 for analyzing (e.g., analyzing statistical information), code 876 for initiating (e.g., initiating or beginning video recording), code 878 for saving (e.g., saving video recording to memory), and code 880 for notifying (e.g., notifying a user).

To enable user interaction, computing system 800 includes an input device 845, which can represent any number of input mechanisms, such as a microphone for speech, a camera for generating images or video, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A recording device, comprising: at least one memory; and one or more processors coupled to the at least one memory and configured to: receive sensor data indicating an orientation associated with the recording device; detect a difference between statistical information associated with a first frame captured by a first video recording element and statistical information associated with a second frame captured by the first video recording element; determining whether to initiate video recording via the first video recording element based on the orientation and the detected difference; initiate the video recording based on the determination; and save the video recording to the at least one memory.

Aspect 2. The recording device of aspect 1, wherein the detected difference comprises a rate of change associated with frame transitions of the data captured by the first video recording element.

Aspect 3. The recording device of any one of aspects 1-2, wherein: the one or more processors are configured to detect whether a user is interacting with a user interface of the recording device; and the one or more processors are configured to determine whether to initiate the video recording based on the detection of whether the user is interacting with the user interface.

Aspect 4. The recording device of any one of aspects 1-3, wherein: the one or more processors are further configured to analyze a gaze associated with a user of the recording device; and the one or more processors are configured to determine whether to initiate the video recording based on the analysis of the gaze.

Aspect 5. The recording device of aspect 4, wherein: the one or more processors are further configured to receive data from a second video recording element capturing a scene including the user; and to analyze the gaze associated with the user, the one or more processors are configured to determine whether the user is gazing at a screen of the recording device based on the data from the second video recording element.

Aspect 6. The recording device of aspect 5, wherein the second video recording element is different than the first video recording element.

Aspect 7. The recording device of any one of aspects 5-6, wherein the second video recording element is a front-facing camera of the recording device, and wherein the first video recording element is a rear-facing camera of the recording device.

Aspect 8. The recording device of any one of aspects 1-7, wherein the sensor data is received from a gyroscope or accelerometer.

Aspect 9. The recording device of any one of aspects 1-8, wherein the one or more processors are configured to receive an input from a user to start a video mode of the recording device prior to determining whether to initiate the video recording.

Aspect 10. The recording device of aspect 9, wherein initiating the video mode comprises opening an application for recording video.

Aspect 11. The recording device of any one of aspects 1-10, wherein: the one or more processors are further configured to analyze whether the first video recording element is focused on an object in a scene captured by the first video recording element; and the one or more processors are configured to determine whether to initiate the video recording based on whether the first video recording element is focused on the object.

Aspect 12. The recording device of any one of aspects 1-11, wherein: the one or more processors are further configured to receive a saliency input indicating a visually salient region of a scene captured by the first video recording element; and the one or more processors are configured to determine whether to initiate the video recording based on the saliency input.

Aspect 13. The recording device of any one of aspects 1-12, wherein, to initiate the video recording, the one or more processors are configured to send a notification to a user to select an option that initiates the video recording.

Aspect 14. The recording device of any one of aspects 1-13, wherein the one or more processors are configured to: begin recording a low-resolution video via the first video recording element; after beginning to record the low-resolution video, send a notification to a user of the recording device that an option to begin the video recording has not been selected; and initiate the video recording after sending the notification.

Aspect 15. The recording device of any one of aspects 1-14, wherein the one or more processors are further configured to stop the video recording based on at least one of: a difference between statistical information associated with a third frame captured by the first video recording element and statistical information associated with a fourth frame captured by the first video recording element; whether a user is interacting with a user interface of the recording device; a gaze associated with the user of the recording device; the sensor data; whether the first video recording element is focused on an object in a scene captured by the first video recording element; or a saliency input indicating a visually salient region of a scene captured by the first video recording element.

Aspect 16. A method for video recording by recording device, comprising: receiving sensor data indicating an orientation associated with the recording device; detecting a difference between statistical information associated with a first frame captured by a first video recording element and statistical information associated with a second frame captured by the first video recording element; determining whether to initiate video recording via the first video recording element based on the orientation and the detected difference; initiating the video recording based on the determination; and saving the video recording to at least one memory.

Aspect 17. The method of aspect 16, wherein the detected difference comprises a rate of change associated with frame transitions of the data captured by the first video recording element.

Aspect 18. The method of any one of aspects 16-17, wherein: the method further comprises detecting whether a user is interacting with a user interface of the recording device; and determining whether to initiate the video recording is further based on the detection of whether the user is interacting with the user interface.

Aspect 19. The method of any one of aspects 16-18, wherein: the method further comprises analyzing a gaze associated with a user of the recording device; and determining whether to initiate the video recording is further based on the analysis of the gaze.

Aspect 20. The method of aspect 19, wherein: the method further comprises receiving data from a second video recording element capturing a scene including the user; and analyzing the gaze associated with the user includes determining whether the user is gazing at a screen of the recording device based on the data from the second video recording element.

Aspect 21. The method of aspect 20, wherein the second video recording element is different than the first video recording element.

Aspect 22. The method of any one of aspects 20-21, wherein the second video recording element is a front-facing camera of the recording device, and wherein the first video recording element is a rear-facing camera of the recording device.

Aspect 23. The method of any one of aspects 16-22, wherein the sensor data is received from a gyroscope or accelerometer.

Aspect 24. The method of any one of aspects 16-23, further comprising receiving an input from a user to start a video mode of the recording device prior to determining whether to initiate the video recording.

Aspect 25. The method of aspect 24, wherein initiating the video mode comprises opening an application for recording video.

Aspect 26. The method of any one of aspects 16-25, further comprising analyzing whether the first video recording element is focused on an object in a scene captured by the first video recording element, wherein determining whether to initiate the video recording is further based on whether the first video recording element is focused on the object.

Aspect 27. The method of any one of aspects 16-26, wherein: the method further comprises receiving a saliency input indicating a visually salient region of a scene captured by the first video recording element; and determining whether to initiate the video recording is further based on the saliency input.

Aspect 28. The method of any one of aspects 16-27, wherein initiating the video recording comprises sending a notification to a user to select an option that initiates the video recording.

Aspect 29. The method of any one of aspects 16-28, further comprising: beginning recording a low-resolution video via the first video recording element; after beginning to record the low-resolution video, sending a notification to a user of the recording device that an option to begin the video recording has not been selected; and initiating the video recording after sending the notification.

Aspect 30. A computer-readable medium comprising at least one instruction for causing a computer or processor to perform operations according to any of aspects 1 to 29.

Aspect 31. An apparatus for video recording, the apparatus including means for performing operations according to any of aspects 1 to 29.

Aspect 32. An apparatus for video recording. The apparatus includes at least one memory and at least one processor coupled to the at least one memory. The at least one processor is configured to perform operations according to any of aspects 1 to 29.

What is claimed is:

1. A recording device, comprising:
at least one memory; and
one or more processors coupled to the at least one memory and configured to:
receive sensor data indicating an orientation associated with the recording device;
detect a difference between statistical information associated with a first frame captured by a first video recording element and statistical information associated with a second frame captured by the first video recording element;
determining whether to initiate video recording via the first video recording element based on the orientation and the detected difference;
initiate the video recording based on the determination; and
save the video recording to the at least one memory.

2. The recording device of claim 1, wherein the detected difference comprises a rate of change associated with frame transitions of the data captured by the first video recording element.

3. The recording device of claim 1, wherein:
the one or more processors are configured to detect whether a user is interacting with a user interface of the recording device; and
the one or more processors are configured to determine whether to initiate the video recording based on the detection of whether the user is interacting with the user interface.

4. The recording device of claim 1, wherein:
the one or more processors are further configured to analyze a gaze associated with a user of the recording device; and
the one or more processors are configured to determine whether to initiate the video recording based on the analysis of the gaze.

5. The recording device of claim 4, wherein:
the one or more processors are further configured to receive data from a second video recording element capturing a scene including the user; and
to analyze the gaze associated with the user, the one or more processors are configured to determine whether the user is gazing at a screen of the recording device based on the data from the second video recording element.

6. The recording device of claim 5, wherein the second video recording element is different than the first video recording element.

7. The recording device of claim 5, wherein the second video recording element is a front-facing camera of the recording device, and wherein the first video recording element is a rear-facing camera of the recording device.

8. The recording device of claim 1, wherein the sensor data is received from a gyroscope or accelerometer.

9. The recording device of claim 1, wherein the one or more processors are configured to receive an input from a user to start a video mode of the recording device prior to determining whether to initiate the video recording.

10. The recording device of claim 9, wherein initiating the video mode comprises opening an application for recording video.

11. The recording device of claim 1, wherein:
the one or more processors are further configured to analyze whether the first video recording element is focused on an object in a scene captured by the first video recording element; and
the one or more processors are configured to determine whether to initiate the video recording based on whether the first video recording element is focused on the object.

12. The recording device of claim 1, wherein:
the one or more processors are further configured to receive a saliency input indicating a visually salient region of a scene captured by the first video recording element; and
the one or more processors are configured to determine whether to initiate the video recording based on the saliency input.

13. The recording device of claim 1, wherein, to initiate the video recording, the one or more processors are configured to send a notification to a user to select an option that initiates the video recording.

14. The recording device of claim 1, wherein the one or more processors are configured to:
begin recording a low-resolution video via the first video recording element;
after beginning to record the low-resolution video, send a notification to a user of the recording device that an option to begin the video recording has not been selected; and
initiate the video recording after sending the notification.

15. The recording device of claim 1, wherein the one or more processors are further configured to stop the video recording based on at least one of:
a difference between statistical information associated with a third frame captured by the first video recording element and statistical information associated with a fourth frame captured by the first video recording element;
whether a user is interacting with a user interface of the recording device;
a gaze associated with the user of the recording device;
the sensor data;
whether the first video recording element is focused on an object in a scene captured by the first video recording element; or
a saliency input indicating a visually salient region of a scene captured by the first video recording element.

16. A method for video recording by recording device, comprising:
receiving sensor data indicating an orientation associated with the recording device;
detecting a difference between statistical information associated with a first frame captured by a first video recording element and statistical information associated with a second frame captured by the first video recording element;
determining whether to initiate video recording via the first video recording element based on the orientation and the detected difference;
initiating the video recording based on the determination; and
saving the video recording to at least one memory.

17. The method of claim 16, wherein the detected difference comprises a rate of change associated with frame transitions of the data captured by the first video recording element.

18. The method of claim 16, wherein:
the method further comprises detecting whether a user is interacting with a user interface of the recording device; and
determining whether to initiate the video recording is further based on the detection of whether the user is interacting with the user interface.

19. The method of claim 16, wherein:
the method further comprises analyzing a gaze associated with a user of the recording device; and
determining whether to initiate the video recording is further based on the analysis of the gaze.

20. The method of claim 19, wherein:
the method further comprises receiving data from a second video recording element capturing a scene including the user; and
analyzing the gaze associated with the user includes determining whether the user is gazing at a screen of the recording device based on the data from the second video recording element.

21. The method of claim 20, wherein the second video recording element is different than the first video recording element.

22. The method of claim 20, wherein the second video recording element is a front-facing camera of the recording device, and wherein the first video recording element is a rear-facing camera of the recording device.

23. The method of claim 16, wherein the sensor data is received from a gyroscope or accelerometer.

24. The method of claim 16, further comprising receiving an input from a user to start a video mode of the recording device prior to determining whether to initiate the video recording.

25. The method of claim 24, wherein initiating the video mode comprises opening an application for recording video.

26. The method of claim 16, further comprising analyzing whether the first video recording element is focused on an object in a scene captured by the first video recording element, wherein determining whether to initiate the video recording is further based on whether the first video recording element is focused on the object.

27. The method of claim 16, wherein:
the method further comprises receiving a saliency input indicating a visually salient region of a scene captured by the first video recording element; and
determining whether to initiate the video recording is further based on the saliency input.

28. The method of claim 16, wherein initiating the video recording comprises sending a notification to a user to select an option that initiates the video recording.

29. The method of claim 16, further comprising:
beginning recording a low-resolution video via the first video recording element;
after beginning to record the low-resolution video, sending a notification to a user of the recording device that an option to begin the video recording has not been selected; and
initiating the video recording after sending the notification.

30. A non-transitory computer-readable medium having instructions, which when executed by one or more processors of a recording device, cause the recording device to:
receive sensor data indicating an orientation associated with the recording device;
detect a difference between statistical information associated with a first frame captured by a first video recording element and statistical information associated with a second frame captured by the first video recording element;
determining whether to initiate video recording via the first video recording element based on the orientation and the detected difference;
initiate the video recording based on the determination; and
save the video recording.
